(19) United States
(12) Patent Application Publication
(10) Pub. No.: US 2024/0201682 A1
(43) Pub. Date: Jun. 20, 2024

(54) DEVICE FOR DETERMINING OPERATIONAL STATUS OF SENSOR AND METHOD THEREOF

(71) Applicant: Doosan Enerbility Co., Ltd., Changwon (KR)

(72) Inventors: Jung Min LEE, Seoul (KR); Jun Sang YU, Seongnam (KR)

(21) Appl. No.: 18/518,483

(22) Filed: Nov. 23, 2023

(30) Foreign Application Priority Data
Dec. 16, 2022 (KR) 10-2022-0177319

(51) Int. Cl. G05B 23/02

(52) U.S. Cl. CPC G05B 23/0283; G05B 23/024; G05B 23/0254

(57) ABSTRACT

Disclosed is a device for determining the operational status of a sensor configured to: determine initial parameters of a Bayesian model and a degree of a polynomial regression model based on historical data of a target sensor and a reference sensor; infer a posterior distribution of a regression coefficient and an error term of a regression curve using the polynomial regression model and the Bayesian model; set a credible interval based on the posterior distribution of the regression coefficient and the error term of the regression curve, and set control lines of data of the target sensor using the credible interval; determine an accuracy of the target sensor based on current data of the target sensor and the set control line; and control an operational status of the target sensor based on the accuracy.

### CROSS-REFERENCE TO RELATED APPLICATIONS

The present application claims priority to Korea Patent Application No. 10-2022-0177319, filed on Dec. 16, 2022, the entire contents of which are incorporated herein for all purposes by this reference.

### BACKGROUND

Generally, performance degradation or failure of a sensor may be caused by a lifetime limit, external shock, etc. When there occurs a problem in the sensor, accuracy and reliability of measured data are reduced and therefore, replacement or repair of the sensor is required.

Further, the reduction in reliability of the sensor data means that the sensor itself is not valid any more. Therefore, to ensure the continuity of a facility in which the sensor is mounted and operated, there is a need for a process of validating whether the sensor itself is valid through the real-time monitoring and analysis of the sensor data.

### SUMMARY

Exemplary embodiments of the present disclosure relate to a device and a method for determining the operational status of a sensor.

An object of the present disclosure is to provide a device and a method for determining the operational status of a sensor, which can intuitively monitor the validity of a sensor by providing control lines of a correlation between a target sensor and a reference sensor.

One embodiment is a device for determining the operational status of a sensor, including at least one processor, and at least one memory coupled to the at least one processor, wherein the at least one memory is configured to provide the at least one processor with instructions which, when executed, causes the at least one processor to: determine initial values of parameters of a Bayesian model and a degree of a polynomial regression model based on historical data of a target sensor and historical data of a reference sensor; infer a posterior distribution of a regression coefficient and an error term of a regression curve representing a correlation between the historical data of the target sensor and the historical data of the reference sensor using the polynomial regression model and the Bayesian model; set a credible interval based on the posterior distribution of the regression coefficient and the error term of the regression curve, and set control lines for data of the target sensor using the credible interval; determine an accuracy of the target sensor based on current data of the target sensor and the control line; and control an operational status of the target sensor based on the accuracy.

In addition, the at least one processor may be further configured to determine the historical data of the reference sensor using a distance correlation between the historical data of the target sensor and historical data of a plurality of sensors not selected as the target sensor.

In addition, the at least one processor may be further configured to replace a prior distribution determined based on the polynomial regression model with a posterior distribution of a previous polynomial regression model, and set a likelihood function.

In addition, the at least one processor may be further configured to validate the posterior distribution of the regression coefficient and the error term of the regression curve based on a preset method.

In addition, the at least one processor may be further configured to set the credible interval based on a highest posterior density (HPD) value having a preset percentage (%) of the posterior distribution of the regression coefficient and of the error term of the regression curve, and set control lines of the data of the target sensor using lower and upper boundary values of the posterior distribution of the regression coefficient and the error term of the regression curve, with the lower and upper boundary values corresponding to lower and upper limits of the credible interval, respectively.

Another embodiment is a method for determining an operational status of a sensor, including: determining initial values of parameters of a Bayesian model and a degree of a polynomial regression model based on historical data of a target sensor and historical data of a reference sensor; inferring a posterior distribution of a regression coefficient and an error term of a regression curve representing a correlation between the historical data of the target sensor and the historical data of the reference sensor using the polynomial regression model and the Bayesian model; setting a credible interval based on the posterior distribution of the regression coefficient and the error term of the regression curve, and setting control lines of data of the target sensor using the set credible interval; determining an accuracy of the target sensor based on current data of the target sensor and the control lines and controlling an operational status of the target sensor based on the accuracy.

In addition, the method for validating validity of a sensor may further include: determining the historical data of the reference sensor using a distance correlation between the historical data of the target sensor and historical data of a plurality of sensors not selected as the target sensor.

In addition, the inferring of the posterior distribution of the regression coefficient and the error term of a regression curve may include replacing a prior distribution determined based on the polynomial regression model with a posterior distribution of a previous polynomial regression model, and setting a likelihood function.

In addition, the inferring of the posterior distribution of the regression coefficient and the error term of the regression curve may include validating the posterior distribution of the regression coefficient and the error term of the regression curve based on a preset method.

In addition, the setting of the control lines of data of the target sensor may include setting the credible interval based on a highest posterior density (HPD) value having a preset percentage (%) of the posterior distribution of the regression coefficient and the error term of the regression curve; and setting control lines of the data of the target sensor using lower and upper boundary values of the posterior distribution of the regression coefficient and the error term of the regression curve, with the lower and upper boundary values corresponding to lower and upper limits of the credible interval.

According to the present disclosure, it is possible to intuitively monitor the validity of a sensor by providing control lines of a correlation between a target sensor and a reference sensor.

Further, according to the present disclosure, it is possible to adjust control lines by setting a posterior distribution of the previous model as a prior distribution.

Further, according to the present disclosure, it is possible to validate a posterior distribution of parameters of a target sensor.

### BRIEF DESCRIPTION OF THE DRAWINGS

FIG. 1 is a diagram showing a configuration of a device for determining an operational status of a sensor according to an embodiment of the present disclosure.

FIG. 2 is a flowchart explaining a method for determining an operational status of a sensor according to an embodiment of the present disclosure.

FIG. 3 is a flowchart explaining a method for determining an operational status of a sensor according to another embodiment of the present disclosure.

FIG. 4 is a flowchart explaining a method for determining initial values of parameters of a polynomial regression model by a device for determining an operational status of a sensor according to an embodiment of the present disclosure.

FIGS. 5A to 5C are views exemplarily showing a safe region, an attention region, and control lines according to an embodiment of the present disclosure.

FIG. 6 is a flowchart explaining a method for determining an operational status of a sensor to which a polynomial regression model is applied according to an embodiment of the present disclosure.

### DETAILED DESCRIPTION

To clearly illustrate the present invention, parts not related to the description are omitted, and similar parts are denoted by like reference characters throughout the specification.

In addition, in the description, when an element “includes” a certain component, it means that the element may further include other components, rather than excluding them, unless specifically stated otherwise.

Throughout the specification, when a certain portion is “connected” to another portion, this includes not only a case of being “directly connected” but also a case of being “electrically connected” with other elements interposed therebetween.

When it is described that any one part is “above” the other part, it may mean that the part is “directly above the other part or any other part is interposed therebetween. On the contrary, when it is described that any one part is “directly above” the other part, there is no other part interposed therebetween.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention

The terminology used herein is for the purpose of describing embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Terms “below”, “above”, and the like indicating a relative space may be used to describe a relationship more easily between one part with another part illustrated in the drawings. These terms are intended to include other meanings or operations of a device that is being used, in addition to meanings intended in the drawings. For example, when the device in the drawing is inverted, any part described as being “below” other parts may be described as being “above” the other parts. Therefore, the exemplary term “below” includes both of an upper direction and a lower direction. The device may rotate by 90° or other angles, and the terms indicating a relative space are interpreted according thereto.

Although not defined otherwise, all terms including technical terms and scientific terms used herein have the same meanings as those generally understood by a person having ordinary knowledge in the art to which the present invention pertains. Terms defined in a dictionary generally used are additionally interpreted as having a meaning consistent with the related art documents and contents currently disclosed, and unless defined otherwise, are not interpreted as having an ideal or very official meaning.

Hereinafter, with reference to the accompanying drawings, embodiments of the present disclosure will be described in detail so that those of ordinary skill in the art can easily implement them. However, the present disclosure may be embodied in several different forms and is not limited to the embodiments described herein.

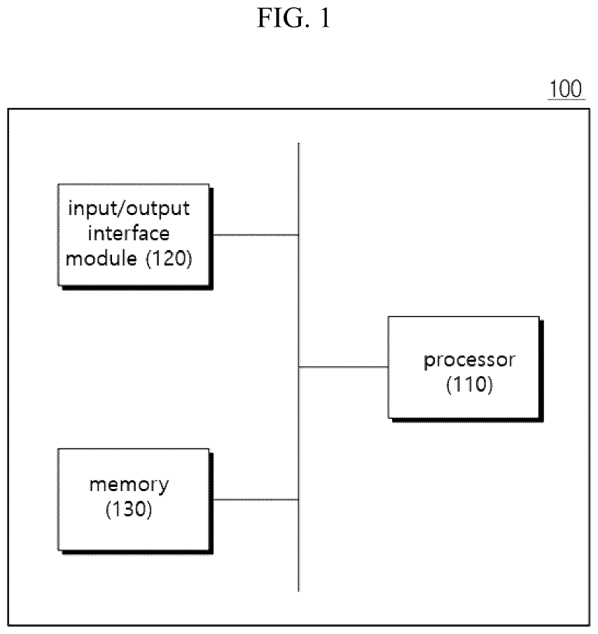

FIG. 1 is a diagram showing a configuration of a device for determining an operational status of a sensor according to an embodiment of the present disclosure.

Referring to FIG. 1, a device 100 for determining the operational status of the sensor according to an embodiment of the present disclosure may include a processor 110, an input/output interface module 120, and a memory 130.

The processor 110, the input/output interface module 120, and the memory 130 included in the device 100 for determining an operational status of a sensor are interconnected and may transmit data to one another.

According to various embodiments, the processor 110 may execute programs or instructions stored in the memory 130. In this case, an operation program (e.g., operating system) for operating the device 100 for determining an operational status of a sensor may be stored in the memory 130.

According to various embodiments, the processor 110 may execute a program for managing information about the device 100 for determining an operational status of a sensor.

According to various embodiments, the processor 110 may execute a program for managing the operation of the device 100 for determining an operational status of a sensor.

According to various embodiments, the processor 110 may execute a program for managing the operation of the input/output interface module 120.

According to various embodiments, the processor 110 may execute a program for controlling an operational status of the sensor.

Here, the term ‘target sensor’ refers to a sensor to be analyzed and the term “reference sensor” refers to a sensor to be compared. The target sensor and the reference sensor may be installed in one or more apparatus, separate from the device. The device 100 analyzes data of the target sensor compared to data of the reference sensor.

### i) Determining Data of a Reference Sensor

According to various embodiments, the processor 110 may obtain a historical data of a target sensor and a historical data of a plurality of sensors not selected as the target sensor through the input/output interface module 120.

According to various embodiments, the processor 110 may set a prior distribution of a historical data of a target sensor. In this case, the prior distribution may be a prior distribution of a regression coefficient and an error term of a regression curve representing a correlation between the historical data of the target sensor and the historical data of the plurality of sensors not selected as the target sensor, though not limited thereto.

According to various embodiments, the processor 110 may set a prior distribution of a historical data of the plurality of sensors which are not selected as the target sensor. In this case, the prior distribution may be a prior distribution of a regression coefficient and an error term of a regression curve representing a correlation between the historical data of the target sensor and the historical data of the plurality of sensors not selected as a target sensor, though not limited thereto.

According to various embodiments, the processor 110 may determine data exhibiting a predetermined high correlation with the historical data of the target sensor. This determination is made among the historical data of the plurality of sensors not selected as the target sensor using distance correlation. However, the method for determining data with the predetermined high correlation is not limited thereto.

According to various embodiments, the processor 110 may determine a sensor whose data exhibits a predetermined high correlation with the historical data of the target sensor, and may designate the sensor as a reference sensor.

According to various embodiments, the processor 110 may set a prior distribution of the historical data of the reference sensor. In this case, the prior distribution may be a prior distribution of a regression coefficient and an error term of a regression curve representing a correlation between the historical data of the target sensor and the historical data of the reference sensor, though not limited thereto.

### ii) Determining Initial Values of Parameters of a Bayesian Model

\textcircled{1} In case that only the historical data of the target sensor and the historical data of the reference sensor are obtained

According to various embodiments, the processor 110 may obtain the historical data of the target sensor and the historical data of the reference sensor through the input/output interface module 120.

According to various embodiments, the processor 110 may determine initial values of parameters of the Bayesian model based on the historical data of the target sensor, the prior distribution of the historical data of the target sensor, the historical data of the reference sensor, and the prior distribution of the historical data of the reference sensor.

According to various embodiments, the processor 110 may obtain a posterior distribution of the historical data of the target sensor and a posterior distribution of the historical data of the reference sensor using the Bayesian model based on the historical data of the target sensor, the prior distribution of the historical data of the target sensor, the historical data of the reference sensor, and the prior distribution of the historical data of the reference sensor.

According to various embodiments, the processor 110 may train the Bayesian model based on the historical data of the target sensor, the prior distribution of the historical data of the target sensor, the historical data of the reference sensor, and the prior distribution of the historical data of the reference sensor so as to determine initial values of parameters of the Bayesian model.

According to various embodiments, the processor 110 may perform sampling in the historical data of the target sensor, the prior distribution of the historical data of the target sensor, the historical data of the reference sensor, and the prior distribution of the historical data of the reference sensor.

According to various embodiments, the processor 110 may sample standard deviation and coefficients of regression polynomial corresponding to each of the historical data of the target sensor, the prior distribution of the historical data of the target sensor, the historical data of the reference sensor, and the prior distribution of the historical data of the reference sensor, but the sampled data are not limited thereto.

According to various embodiments, the processor 110 may perform sampling in the historical data of the target sensor, the prior distribution of the historical data of the target sensor, the historical data of the reference sensor, and the prior distribution of the historical data of the reference sensor between 500 and 1000 times, but the number of sampling operations is not limited thereto.

According to various embodiments, the processor 110 may train the Bayesian model based on training data generated by the sampling performed in the historical data of the target sensor, the prior distribution of the historical data of the target sensor, the historical data of the reference sensor, and the prior distribution of the historical data of the reference sensor so as to determine initial values of parameters of the Bayesian model.

According to various embodiments, the processor 110 may validate a training state of the Bayesian model by comparing the posterior distribution obtained by using the Bayesian model with a preset reference value. At this time, the preset reference value may be an acceptance rate and autocorrelation, but is not limited thereto.

According to various embodiments, the processor 110 may determine re-training of the Bayesian model if the posterior distribution obtained by using the Bayesian model cannot satisfy both a predetermined acceptance rate (for example, 0.2<=acceptance rate <=0.5) and a predetermined autocorrelation (for example, 50% of the sample is within 95% of the credible interval).

According to various embodiments, the processor 110 may train the Bayesian model repeatedly based on new training data sampled in the historical data of the target sensor, the prior distribution of the historical data of the target sensor, the historical data of the reference sensor, and the prior distribution of the historical data of the reference sensor, until the posterior distribution obtained by using the Bayesian model satisfies both a predetermined acceptance rate (for example, 0.2<=acceptance rate <=0.5) and a predetermined autocorrelation (for example, 50% of the sample is within 95% of the credible interval).

According to various embodiments, the processor 110 may stop training of the Bayesian model if the posterior distribution obtained by using the Bayesian model satisfies both the predetermined acceptance rate (for example, 0.2<=acceptance rate <=0.5) and the predetermined autocorrelation (for example, 50% of the sample is within 95% of the credible interval).

\textcircled{2} In case that the prior distribution of the historical data of the target sensor and the prior distribution of the historical data of the reference sensor are further obtained

According to various embodiments, the processor 110 may obtain the prior distribution of the historical data of the target sensor and the prior distribution of the historical data of the reference sensor, in addition to the historical data of the target sensor, and the historical data of the reference sensor, through the input/output interface module 120. In this case, the prior distribution may be the prior distribution of a regression coefficient and an error term of a regression curve representing a correlation between the historical data of the target sensor and the historical data of the reference sensor, though not limited thereto.

According to various embodiments, the processor 110 may determine initial values of parameters of the Bayesian model based on the prior distribution of the historical data of the target sensor, the historical data of the target sensor, the prior distribution of the historical data of the reference sensor, and the historical data of the reference sensor.

According to various embodiments, the processor 110 may obtain a posterior distribution of the historical data of the target sensor and the historical data of the reference sensor using the Bayesian model based on the prior distribution of the historical data of the target sensor, the historical data of the target sensor, the prior distribution of the historical data of the reference sensor, and the historical data of the reference sensor.

According to various embodiments, the processor 110 may train the Bayesian model based on the prior distribution of the historical data of the target sensor, the historical data of the target sensor, the prior distribution of the historical data of the reference sensor, and the historical data of the reference sensor so as to determine initial values of parameters of the Bayesian model.

According to various embodiments, the processor 110 may perform sampling in the historical data of the target sensor, the prior distribution of the historical data of the target sensor, the historical data of the reference sensor, and the prior distribution of the historical data of the reference sensor.

According to various embodiments, the processor 110 may sample a coefficient and a standard deviation of a regression polynomial corresponding to each data in each of the historical data of the target sensor, the prior distribution of the historical data of the target sensor, the historical data of the reference sensor, and the prior distribution of the historical data of the reference sensor, but sampled data are not limited thereto.

According to various embodiments, the processor 110 may perform the sampling in the historical data of the target sensor, the prior distribution of the historical data of the target sensor, the historical data of the reference sensor, and the prior distribution of the historical data of the reference sensor between 500 and 1000 times, but the number of sampling operations is not limited thereto.

According to various embodiments, the processor 110 may train the Bayesian model based on training data generated by the sampling performed in the historical data of the target sensor, the prior distribution of the historical data of the target sensor, the historical data of the reference sensor, and the prior distribution of the historical data of the reference sensor so as to determine initial values of parameters of the Bayesian model.

According to various embodiments, the processor 110 may validate a training state of the Bayesian model by comparing the posterior distribution obtained by using the Bayesian model with a preset reference value. At this time, the preset reference value may be an acceptance rate and autocorrelation, but is not limited thereto.

According to various embodiments, the processor 110 may determine re-training of the Bayesian model if the posterior distribution obtained by using the Bayesian model cannot satisfy both a predetermined acceptance rate (for example, 0.2<=acceptance rate <=0.5) and a predetermined autocorrelation (for example, 50% of the sample is within 95% of the credible interval).

According to various embodiments, the processor 110 may train the Bayesian model repeatedly based on the new training data sampled in the historical data of the target sensor, the posterior distribution of the historical data of the target sensor, the historical data of the reference sensor, and the prior distribution of the historical data of the reference sensor, until the posterior distribution obtained by using the Bayesian model satisfies both the predetermined acceptance rate (for example, 0.2<=acceptance rate <=0.5) and the predetermined autocorrelation (for example, 50% of the sample is within 95% of the credible interval).

According to various embodiments, the processor 110 may stop training of the Bayesian model if the posterior distribution obtained by using the Bayesian model satisfies both the predetermined acceptance rate (for example, 0.2<=acceptance rate <=0.5) and the predetermined autocorrelation (for example, 50% of the sample is within 95% of the credible interval).

iii) Determining a Degree of a Polynomial Regression Model

According to various embodiments, the processor 110 may divide the historical data of the target sensor and the historical data of the reference sensor into a training data set and a validation data set.

According to various embodiments, the processor 110 may set a range for exploring a degree of a polynomial regression model as per [Equation 1] below. The degree of a polynomial regression model refers to a degree of polynomial function used in the polynomial regression model. In this instance, the degree may extend from the first to the tenth, but the degree is not limited thereto.

$$μ = c 1 + c 2 \times x + c 3 \times {x}^{2} + … + cn \times {x}^{n - 1} + σ \qquad [ Equation 1 ]$$

According to various embodiments, the processor 110 may generate a polynomial regression model for each degree with the training data.

According to various embodiments, the processor 110 may calculate a root mean square error (hereinafter referred to as “RMSE”) of the polynomial regression model for each degree, modeled with the training data, by using validation data.

According to various embodiments, the processor 110 may store the difference if the difference between a RMSE of the previous degree and a RMSE of the current degree is smaller than “0”.

According to various embodiments, the processor 110 may store “0” if the difference between a RMSE of the previous degree and a RMSE of the current degree is greater than “0”.

According to various embodiments, the processor 110 may normalize each difference by dividing each difference with a sum of all differences.

According to various embodiments, the processor 110 may determine the cumulative sum as a proper degree of the polynomial regression model if the cumulative sum is equal to or greater than a preset threshold value. For example, the threshold value may be 0.7, but is not limited thereto.

### iv) Inferring the Posterior Distribution of the Data of the Target Sensor

According to various embodiments, the processor 110 may set a prior distribution of a coefficient and a standard deviation based on the determined degree of the polynomial regression model.

According to various embodiments, the processor 110 may determine a regression coefficient of the initial polynomial regression equation as a mean value of the prior distribution of the regression coefficient.

According to various embodiments, the processor 110 may infer the posterior distribution of the regression coefficient and the error term of the regression curve representing the correlation between the historical data of the target sensor and the historical data of the reference sensor, by inputting the set prior distribution, the historical data of the target sensor, and the historical data of the reference sensor into the Bayesian model.

According to various embodiments, the processor 110 may infer the regression coefficient of the polynomial regression model based on the posterior distribution of the regression coefficient and the error term of the regression curve representing the correlation between the historical data of the target sensor and the historical data of the reference sensor.

### v) Attuning Control Lines

According to various embodiments, the processor 110 may adjust control lines for the correlation in response to changes in the conditions associated with the apparatus collecting data from the target sensor (repair, seasonal factor, deterioration, etc.).

According to various embodiments, the processor 110 may update the posterior distribution of the polynomial regression model so that the control lines can be attuned.

According to various embodiments, the processor 110 may update the posterior distribution of the polynomial regression model by using the Bayesian sampling inference on the polynomial regression model by setting the posterior distribution of the previous model as the prior distribution. Here, the posterior distribution of the previous model may mean the posterior distribution of the regression coefficient and the error term (standard deviation) constituting the control line, but the meaning thereof is not limited thereto.

According to various embodiments, the processor 110 may set a likelihood function. At this time, the likelihood function may be a normal distribution function, but is not limited thereto.

According to various embodiments, the processor 110 may set a likelihood function. At this time, the likelihood function may be a function corresponding to the historical data of the target sensor, but is not limited thereto.

According to various embodiments, the processor 110 may input the posterior distribution of the coefficient and the standard deviation of a previous polynomial regression model, along with the determined likelihood function, into the Bayesian model so as to substitute the prior distribution of the coefficient and standard deviation set based on the determined degree of the polynomial regression model.

### vi) Validating the Posterior Distribution

According to various embodiments, the processor 110 may validate the posterior distribution of the regression coefficient and the error term of the regression curve representing the correlation between the historical data of the target sensor and the historical data of the reference sensor based on a preset method.

According to various embodiments, the processor 110 may validate convergence based on an ESS (Effective Sample Size) value (for example, ESS>500) and a R-hat value after Burn-in and Thinning (for example, 0.95<R-hat<1.05).

According to various embodiments, the processor 110 may re-validate the posterior distribution of the regression coefficient and the error term of the regression curve representing the correlation between the historical data of the target sensor and the historical data of the reference sensor after increasing the draw size with equal differences as much as the initial draw size, if the posterior distribution of the regression coefficient and the error term of the regression curve representing the correlation between the historical data of the target sensor and the historical data of the reference sensor does not converge to the reference (the R-hat value (for example, 0.95<R-hat<1.05) and the ESS value (for example, ESS>500)).

According to various embodiments, the processor 110 may dump a sample before the burn-in if the draw size is increased, and may continue the Markov chain from a sample provided immediately after the burn-in period of the increased draw size.

According to various embodiments, the processor 110 may estimate the posterior distribution of the regression coefficient and the error term of the regression curve representing the correlation between the historical data of the target sensor and the historical data of the reference sensor, by means of the Markov chain having the lowest MCSE (Monte Carlo Standard Error) value, if the posterior distribution of the regression coefficient and the error term of the regression curve representing the correlation between the historical data of the target sensor and the historical data of the reference sensor converges to the reference (the R-hat value (for example, 0.95<R-hat<1.05) and the ESS value (for example, ESS>500)).

vii) Setting Control Lines

According to various embodiments, the processor 110 may set a targeted credible interval with respect to the inferred posterior distribution of the regression coefficient and the error term of the regression curve representing the correlation between the historical data of the target sensor and the historical data of the reference sensor, and set control lines for data of the target sensor by using the set credible interval.

According to various embodiments, the processor 110 may set a certain percentage (%) (for example, 50%, 95%) of a region of the posterior distribution of the regression coefficient and the error term of the regression curve representing the correlation between the historical data of the target sensor and the historical data of the reference sensor. The certain percentage of the region is designated as a credible interval. Here, the certain percentage (%) of a region of the posterior distribution of the regression coefficient and the error term of the regression curve representing the correlation between the historical data of the target sensor and the historical data of the reference sensor relates to a highest posterior density (hereinafter referred to as a “HPD”) value, which may change depending on circumstances.

According to various embodiments, the processor 110 may set control lines of the data of the target sensor by using boundary values of the posterior distribution of the regression coefficient and the error term of the regression curve representing the correlation between the historical data of the target sensor and the historical data of the reference sensor. The control lines correspond to a lower limit and an upper limit of the set credible interval.

According to various embodiments, the processor 110 may set probabilistic control lines based on the posterior distribution of the regression coefficient and the error term of the regression curve representing the correlation between the historical data of the target sensor and the historical data of the reference sensor and HPD statistics. Here, since the posterior distribution of the regression coefficient and the error term of the regression curve representing the correlation between the historical data of the target sensor and the historical data of the reference sensor includes the mean value and the standard deviation, the processor 110 may set control lines of the data of the target sensor by setting a certain percentage as the credible interval with respect to the posterior distribution of each of the mean value and the standard deviation, and combining the value of the posterior distribution of the regression coefficient and the error term of the regression curve representing the correlation between the historical data of the target sensor and the historical data of the reference sensor. Thus, the control lines correspond to a lower limit and an upper limit of the credible interval with the specified percentage.

According to various embodiments, the processor 110 may set a safe region, an attention region, and the control lines, by using the HPD value having a preset percentage (for example, 25%, 75%, 2.5%, 97.5%) based on a median value of the posterior distribution of the regression coefficient and the error term of the regression curve representing the correlation between the historical data of the target sensor and the historical data of the reference sensor.

According to various embodiments, the processor 110 may set a region of the posterior distribution of the regression coefficient and the error term of the regression curve representing the correlation between the historical data of the target sensor and the historical data of the reference sensor. The region is considered the safe region, and is characterized by a mean value and a standard deviation that satisfy [Equation 2] and [Equation 3], respectively.

$${\check{μ}}_{hpd 25 \%} \leq {\check{μ}}_{CI 50 \%} \leq {\check{μ}}_{hpd 75 \%} \qquad [ Equation 2 ]$$

$$( {\check{μ}}_{hpd 25 \%} - 3 {\check{σ}}_{hpd 75 \%} \leq {\check{X}}_{CI 50 \%} \leq {\check{μ}}_{hpd 75 \%} + 3 {\check{σ}}_{hpd 75 \%} \qquad [ Equation 3 ]$$

In Equations 2 and 3, \check{μ}_{C150%} and \check{X}_{C150%} represent the mean value and the standard deviation, respectively, at 50% credible interval. \check{μ}_{C150%} refers to 50% credible interval of a dependent variable of the regression, and \check{X}_{C150%} represents the standard deviations generated by combining the HPD statistics. \check{μ}_{hpd75%} and \check{μ}_{hpd25%} represent the upper and lower limits of the mean of the safe region, respectively. \check{μ}_{hpd75%}+3\check{σ}_{hpd75%} and \check{μ}_{hpd25%}−3\check{σ}_{hpd75%} represent the upper and lower limits of the standard deviation of the safe region, respectively.

According to various embodiments, the processor 110 may set a region of the posterior distribution of the regression coefficient and the error term of the regression curve representing the correlation between the historical data of the target sensor and the historical data of the reference sensor. The region is considered the attention region, and is characterized by a mean value and a standard deviation that satisfy [Equation 4] and [Equation 5], respectively.

$${\check{μ}}_{hpd2 \text{.5} \%} \leq {\check{μ}}_{CI95 \%} \leq {\check{μ}}_{hpd97 \text{.5} \%} \qquad [ Equation 4 ]$$

$${\check{μ}}_{hpd 2.5 \%} - 3 {\check{σ}}_{hpd97 \text{.5} \%} \leq {\check{X}}_{CI 95 \%} \leq {\check{μ}}_{hpd 95 \%} + 3 {\check{σ}}_{hpd 97.5 \%} \qquad [ Equation 5 ]$$

Here, \check{μ}_{C195%} and \check{X}_{C195%} represent the mean value and the standard deviation, respectively, at 95% credible interval.

According to various embodiments, the processor 110 may set boundary values of a region of the posterior distribution of the regression coefficient and the error term of the regression curve representing the correlation between the historical data of the target sensor and the historical data of the reference sensor. The boundary values of the region are considered control lines comprising an upper control line and a lower control line, and are characterized by satisfying [Equation 6].

$${\check{μ}}_{a v g} - 3 {\check{σ}}_{a v g} \leq {\check{X}}_{C L} \leq {\check{μ}}_{a v g} + 3 {\check{σ}}_{a v g} \qquad [ Equation 6 ]$$

In Equation 6, \check{μ}_{avg}+3\check{σ}_{avg} represents an upper control line, and \check{μ}_{avg}−3\check{σ}_{avg} represents a lower control line.

According to various embodiments, the processor 110 may determine that the target sensor is normal or the data of the target sensor are accurate, if the data of the target sensor exists in the safe region and the attention region which are between the upper and lower control lines.

According to various embodiments, the processor 110 may decide that the target sensor is abnormal (sensor is defective) or the data of the target sensor are inaccurate if the data of the target sensor exists in a region which is higher than an upper control line or a region which is lower than a lower control line.

viii) Validating the Validity of the Target Sensor

According to various embodiments, the processor 110 may obtain current data of the target sensor through the input/output interface module 120.

According to various embodiments, the processor 110 may compare the current data of the target sensor with the control lines to validate the validity of the target sensor.

According to various embodiments, the processor 110 may decide that the target sensor is valid (normal) if the current data of the target sensor exists in the safe region and the attention region which are between the control lines.

According to various embodiments, the processor 110 may decide that the target sensor is invalid (sensor is defective) if the current data of the target sensor exists in a region higher than the upper control line or in a region lower than the lower control line.

The input/output interface module 120 may be connected to an external device (for example, a server or sensor control device) through a network. The processor 110 may control the operational status of the sensor by transmitting a signal to the external device that manages the sensor. The operational status may include turning on/off the target sensor or determining the activity of sensor data collection from the target sensor.

The processor 110 may send a signal to the sensor for operational control. In this scenario, the sensor is equipped with a circuit capable of communication with the device 100.

The input/output interface module 120 may obtain data from an external device.

The input/output interface module 120 may obtain the historical data of the target sensor.

The input/output interface module 120 may obtain the historical data of the reference sensor.

The input/output interface module 120 may obtain the prior distribution of the historical data of the target sensor.

The input/output interface module 120 may obtain the prior distribution of the historical data of the reference sensor.

The input/output interface module 120 may obtain a user's input.

The input/output interface module 120 may output a result of determining the operational status of the target sensor.

The input/output interface module 120 may be integrally provided with the device for determining the operational status of a sensor.

The input/output interface module 120 may be provided separately from the device 100 for determining the operational status of a sensor.

The input/output interface module 120 may be a separate device to be communicatively connected to the device 100 for determining the operational status of a sensor.

The input/output interface module 120 may include a port (for example, a USB port) for connecting to an external device.

The input/output interface module 120 may include a monitor, a touch screen, a mouse, an electronic pen, a microphone, a keyboard, a speaker, an earphone, a headphone, or a touch pad.

The processor 110 may inform an operator of a facility (e.g., a power plant) about the validity of the sensor through an output device, which includes the monitor, the speaker, etc., by displaying relevant information on the monitor, emitting audible alerts through the speaker, or employing other suitable means in order for the operator to promptly assess and respond to the sensor's status and take any necessary actions (e.g., replacing a defective sensor) to ensure the smooth operation of the facility.

The memory 130 may store data obtained through the input/output interface module 120.

The memory 130 may store data obtained by the processor 110.

The memory 130 may store the safe region set by the processor 110.

The memory 130 may store the attention region set by the processor 110.

The memory 130 may store the control lines set by the processor 110.

The memory 130 may store a result of determining the operational status of the target sensor.

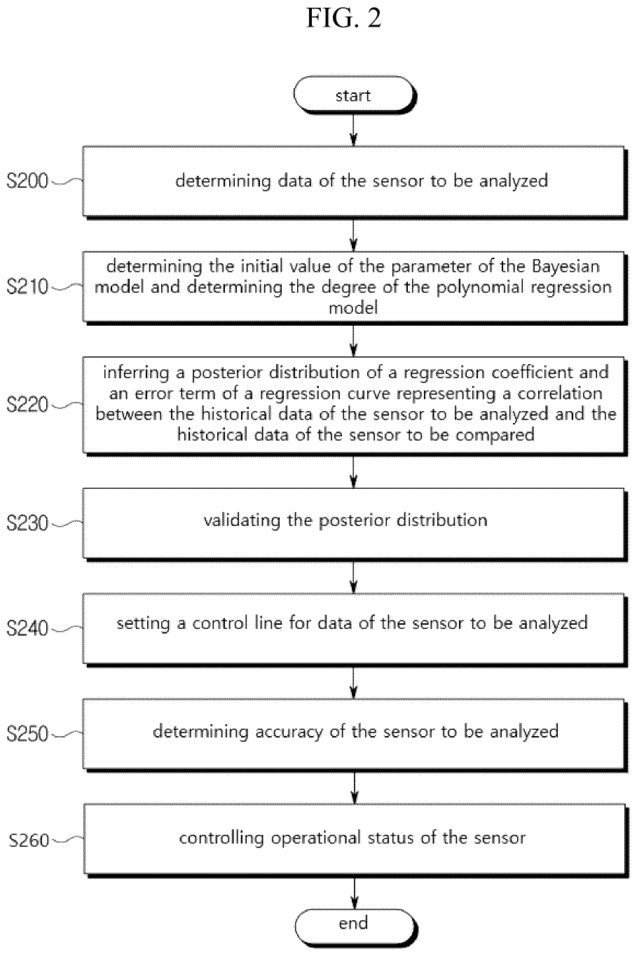

FIG. 2 is a flowchart explaining a method for determining the operational status of the sensor according to an embodiment of the present disclosure.

Referring to FIG. 2, the method for determining the operational status of the sensor includes determining data of the target sensor (S200), determining the initial value of the parameter of the Bayesian model and determining the degree of the polynomial regression model (S210), inferring a posterior distribution of a regression coefficient and an error term of a regression curve representing a correlation between the historical data of the target sensor and the historical data of the reference sensor (S220), validating the posterior distribution (S230), setting control lines for data of the target sensor (S240), determining accuracy of the target sensor (S250) and control the operational status of the target sensor (S260).

In step of S200, the device 100 for determining the operational status of a sensor may obtain the historical data of the target sensor and the historical data of a plurality of sensors which are not selected as the target sensor.

In step of S200, the device 100 for determining the operational status of a sensor may determine data having high correlation with the historical data of the target sensor among the historical data of the plurality of sensors not selected as the target sensor using distance correlation, and decide the determined data as the data of the reference sensor.

In step of S200, the device 100 for determining the operational status of a sensor may set the prior distribution of the historical data of the target sensor. In this case, the prior distribution may be the prior distribution of the regression coefficient and the error term of the regression curve representing the correlation between the historical data of the target sensor and the historical data of the plurality of sensors not selected as the target sensor, though not limited thereto.

In step of S200, the device 100 for determining the operational status of a sensor may set the prior distribution of the historical data of the reference sensor. In this case, the prior distribution may be the prior distribution of the regression coefficient and the error term of the regression curve representing the correlation between the historical data of the target sensor and the historical data of the reference sensor, though not limited thereto.

In step of S210, the device 100 for determining the operational status of a sensor may perform sampling in the historical data of the target sensor, the prior distribution of the historical data of the target sensor, the historical data of the reference sensor, and the prior distribution of the historical data of the reference sensor.

In step of S210, the device 100 for determining the operational status of a sensor may train the Bayesian model based on training data sampled in the historical data of the target sensor, the prior distribution of the historical data of the target sensor, the historical data of the reference sensor, and the prior distribution of the historical data of the reference sensor.

In step of S210, the device 100 for determining the operational status of a sensor may train the Bayesian model repeatedly based on the new training data sampled in the historical data of the target sensor, the posterior distribution of the historical data of the target sensor, the historical data of the reference sensor, and the prior distribution of the historical data of the reference sensor, until the posterior distribution obtained by using the Bayesian model satisfies both a predetermined acceptance rate (for example, 0.2<=acceptance rate <=0.5) and a predetermined autocorrelation (for example, 50% of the sample is within 95% of the credible interval).

In step of S210, the device 100 for determining the operational status of a sensor may stop training of the Bayesian model if the posterior distribution obtained by using the Bayesian model satisfies both the predetermined acceptance rate (for example, 0.2<=acceptance rate <=0.5) and the predetermined autocorrelation (for example, 50% of the sample is within 95% of the credible interval).

In step of S210, the device 100 for determining the operational status of a sensor may set a range from the first to the tenth degree to investigate the polynomial regression degree of the polynomial regression equation.

In step of S210, the device 100 for determining the operational status of a sensor may model the polynomial regression model with the training data for each degree.

In step of S210, the device 100 for determining the operational status of a sensor may calculate a RMSE of the polynomial regression model, and determine a degree to be employed for the polynomial regression model by using the calculated RMSE.

In step of S220, the device 100 for determining the operational status of a sensor may set the prior distribution of the coefficient and the standard deviation based on the selected degree of the polynomial regression equation.

In step of S220, the device 100 for determining the operational status of a sensor may set the regression coefficient of the initial polynomial regression equation as a mean value of the prior distribution of the regression coefficient.

In step of S220, the device 100 for determining the operational status of a sensor may infer the posterior distribution of the regression coefficient and the error term of the regression curve representing the correlation between the historical data of the target sensor and the historical data of the reference sensor, by inputting the set prior distribution, the historical data of the target sensor, and the historical data of the reference sensor into the optimized Bayesian model.

In step of S220, the device 100 for determining the operational status of a sensor may infer the regression coefficient of the polynomial regression model based on the posterior distribution of the regression coefficient and the error term of the regression curve representing the correlation between the historical data of the target sensor and the historical data of the reference sensor.

In step of S230, the device 100 for determining the operational status of a sensor may validate convergence based on an ESS value (for example, ESS>500) and a R-hat value after Burn-in and Thinning (for example, 0.95<R-hat<1.05).

In step of S230, the device 100 for determining the operational status of a sensor may dump a sample before the burn-in if the draw size is increased, and may continue the Markov chain from a sample provided immediately after the burn-in period of the increased draw size.

In step of S230, the device 100 for determining the operational status of a sensor may estimate the posterior distribution of the parameters of the data of the target sensor by means of the Markov chain having the lowest MCSE value, if the posterior distribution of the regression coefficient and the error term of the regression curve representing the correlation between the historical data of the target sensor and the historical data of the reference sensor converges to the reference (the R-hat value (for example, 0.95<R-hat<1.05) and the ESS value (for example, ESS>500)).

In step of S240, the device 100 for determining the operational status of a sensor may set a predetermined percentage (%)(for example, 50%, 95%) of a region of the posterior distribution of the regression coefficient and the error term of the regression curve representing the correlation between the historical data of the target sensor and the historical data of the reference sensor as a credible interval.

In step of S240, the device 100 for determining the operational status of a sensor may set the control lines of the data of the target sensor by using boundary values of the posterior distribution of the regression coefficient and the error term of the regression curve representing the correlation between the historical data of the target sensor and the historical data of the reference sensor. The control lines correspond to the upper and lower limits of credible interval determined to be employed.

In step of S250, the device 100 for determining the operational status of a sensor may decide that the target sensor is valid (normal) if the current data of the target sensor exists in the safe region and the attention region which are between the control lines.

In step of S250, the device 100 for determining the operational status of a sensor may decide that the target sensor is invalid (sensor is defective) if the current data of the target sensor exists in a region higher than the upper control line or in a region lower than the lower control line.

In Step S360, the device 100 for determining the operational status of a sensor may control the operational status of the target sensor by transmitting a signal to the external device that manages the target sensor or by directly transmitting a signal to the target sensor.

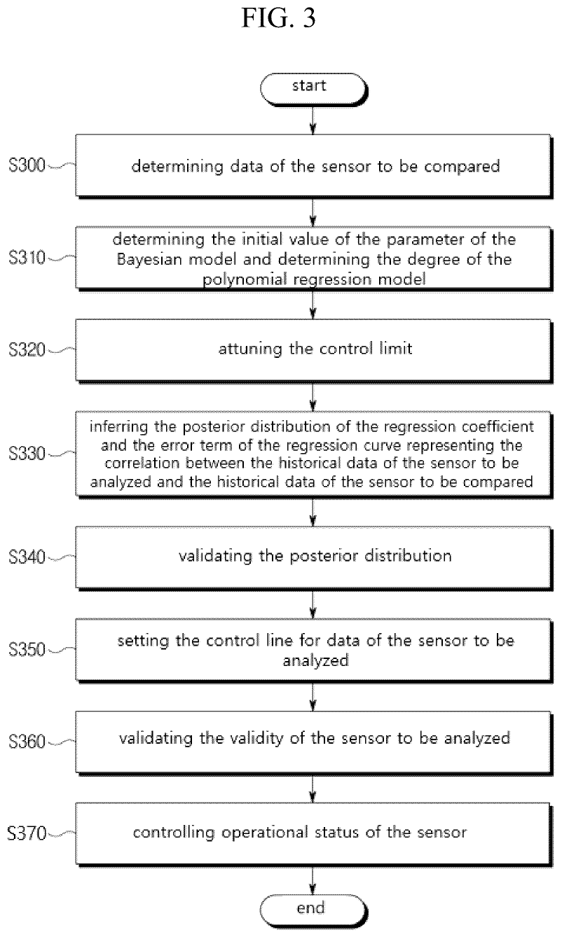

FIG. 3 is a flowchart explaining a method for determining the operational status of a sensor according to another embodiment of the present disclosure.

Referring to FIG. 3, the method for determining the operational status of the sensor includes determining data of the reference sensor (S300), determining the initial value of the parameter of the Bayesian model and determining the degree of the polynomial regression model (S310), attuning the control lines (S320), inferring the posterior distribution of the regression coefficient and the error term of the regression curve representing the correlation between the historical data of the target sensor and the historical data of the reference sensor (S330), validating the posterior distribution (S340), setting the control lines for data of the target sensor (S350), determining the operational status of the target sensor (S360), and controlling operational status of the target sensor (S370).

In step of S300, the device 100 for determining the operational status of a sensor may obtain the historical data of the target sensor and the historical data of a plurality of sensors which are not selected as the target sensor.

In step of S300, the device 100 for determining the operational status of a sensor may determine data having high correlation with the historical data of the target sensor among the historical data of the plurality of sensors not selected as the target sensor using distance correlation, and decide the determined data as the data of the reference sensor.

In step of S300, the device 100 for determining the operational status of a sensor may set a prior distribution of the historical data of the target sensor. In this case, the prior distribution may be the prior distribution of the regression coefficient and the error term of a regression curve representing the correlation between the historical data of the target sensor and the historical data of the plurality of sensors not selected as the target sensor, though not limited thereto.

In step of S300, the device 100 for determining the operational status of a sensor may set the prior distribution of the historical data of the reference sensor. In this case, the prior distribution may be the prior distribution of the regression coefficient and the error term of the regression curve representing the correlation between the historical data of the target sensor and the historical data of the reference sensor, though not limited thereto.

In step of S310, the device 100 for determining the operational status of a sensor may perform sampling in the historical data of the target sensor, the prior distribution of the historical data of the target sensor, the historical data of the reference sensor, and the prior distribution of the historical data of the reference sensor.

In step of S310, the device 100 for determining the operational status of a sensor may train the Bayesian model based on training data generated by the sampling performed in the historical data of the target sensor, the prior distribution of the historical data of the target sensor, the historical data of the reference sensor, and the prior distribution of the historical data of the reference sensor.

In step of S310, the device 100 for determining the operational status of a sensor may train the Bayesian model repeatedly based on the new training data sampled in the historical data of the target sensor, the posterior distribution of the historical data of the target sensor, the historical data of the reference sensor, and the prior distribution of the historical data of the reference sensor, until the posterior distribution obtained by using the Bayesian model satisfies both the acceptance rate (for example, 0.2<=acceptance rate <=0.5) and the autocorrelation (for example, 50% of the sample is within 95% of the credible interval).

In step of S310, the device 100 for determining the operational status of a sensor may stop training of the Bayesian model if the posterior distribution obtained by using the Bayesian model satisfies both the acceptance rate (for example, 0.2<=acceptance rate <=0.5) and the autocorrelation (for example, 50% of the sample is within 95% of the credible interval).

In step of S310, the device 100 for determining the operational status of a sensor may set a range from the first to the tenth degree to investigate the polynomial regression degree of the polynomial regression equation.

In step of S310, the device 100 for determining the operational status of a sensor may model the polynomial regression model with the training data by each degree.

In step of S310, the device 100 for determining the operational status of a sensor may calculate a RMSE of the polynomial regression model, and determine a proper degree of the polynomial regression model by using the calculated RMSE.

In step of S320, the device 100 for determining the operational status of a sensor may update the control lines of the correlation as a condition to which a device for obtaining the data by the target sensor belongs changes (repair, seasonal factor, deterioration, etc.).

In step of S320, the device 100 for determining the operational status of a sensor may update the posterior distribution of the polynomial regression model so that the control lines can be attuned.

In step of S320, the device 100 for determining the operational status of a sensor may update the posterior distribution of the polynomial regression model by using the Bayesian sampling inference on the polynomial regression model by setting the posterior distribution of a previous model as the prior distribution. Here, the posterior distribution of the previous model may mean the posterior distribution of the regression coefficient and the error term (standard deviation) constituting the control lines, but the meaning thereof is not limited thereto.

In step of S320, the device 100 for determining the operational status of a sensor may set a proper likelihood function. At this time, the proper likelihood function may be a normal distribution function, but is not limited thereto.

In step of S320, the device 100 for determining the operational status of a sensor may input the posterior distribution of the coefficient and the standard deviation of the previous model, which has replaced the prior distribution of the coefficient and the standard deviation set based on the determined degree of the polynomial regression model, and the set likelihood function into the Bayesian model so as to replace the prior distribution of the coefficient and standard deviation set based on the determined degree of the polynomial regression model.

In step of S330, the device 100 for determining the operational status of a sensor may set the prior distribution of the coefficient and the standard deviation based on the determined degree of the polynomial regression equation.

In step of S330, the device 100 for determining the operational status of a sensor may infer the posterior distribution of the regression coefficient and the error term of the regression curve representing the correlation between the historical data of the target sensor and the historical data of the reference sensor, by inputting the set prior distribution, the historical data of the target sensor, and the historical data of the reference sensor into the optimized Bayesian model.

In step of S330, the device 100 for determining the operational status of a sensor may infer the regression coefficient of the polynomial regression model based on the posterior distribution of the regression coefficient and the error term of the regression curve representing the correlation between the historical data of the target sensor and the historical data of the reference sensor.

In step of S340, the device 100 for determining the operational status of a sensor may validate convergence based on an ESS value (for example, ESS>500) and a R-hat value after Burn-in and Thinning (for example, 0.95<R-hat<1.05).

In step of S340, the device 100 for determining the operational status of a sensor may dump a sample before the burn-in if the draw size is increased, and may continue the Markov chain from a sample provided immediately after the burn-in period of the increased draw size.

In step of S340, the device 100 for determining the operational status of a sensor may estimate the posterior distribution of the parameters of the data of the target sensor by means of the Markov chain having the lowest MCSE value, if the posterior distribution of the regression coefficient and the error term of the regression curve representing the correlation between the historical data of the target sensor and the historical data of the reference sensor converges to the reference (the R-hat value (for example, 0.95<R-hat<1.05) and the ESS value (for example, ESS>500)).

In step of S350, the device 100 for determining the operational status of a sensor may set a certain percentage (%) (for example, 50%, 95%) of a region of the posterior distribution of the regression coefficient and the error term of the regression curve representing the correlation between the historical data of the target sensor and the historical data of the reference sensor as a credible interval.

In step of S350, the device 100 for determining the operational status of a sensor may set the control lines of the data of the target sensor by using a boundary value of the posterior distribution of the regression coefficient and the error term of the regression curve representing the correlation between the historical data of the target sensor and the historical data of the reference sensor.

In step of S360, the device 100 for determining the operational status of a sensor may decide that the target sensor is valid (normal) if the current senso data of the target sensor exists in the safe region and the attention region which are between the control lines.

In step of S360, the device 100 for determining the operational status of a sensor may decide that the target sensor is invalid (sensor is defective) if the current data of the target sensor exists in a region higher than the upper control line or in a region lower than the lower control line.

In Step S370, the device 100 for determining the operational status of a sensor may control the operational status of the target sensor by transmitting a signal to the external device that manages the target sensor or by directly transmitting a signal to the target sensor.

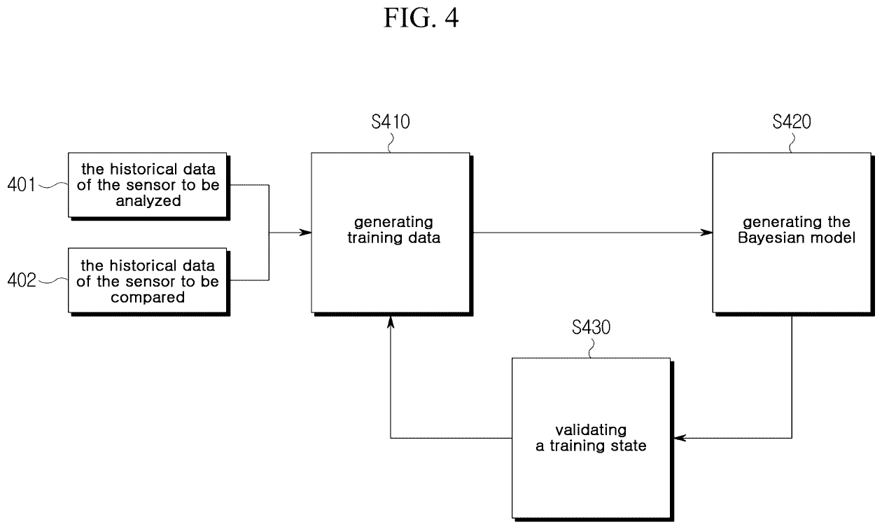

FIG. 4 is a flowchart explaining a method for optimizing initial values of parameters of the polynomial regression model by the device 100 for determining the operational status of a sensor according to an embodiment of the present disclosure.

Referring to FIG. 4, the device 100 for determining the operational status of a sensor may obtain the historical data of the target sensor 401 and the historical data of the reference sensor 402.

According to various embodiments, in step of S410, the device 100 for determining the operational status of a sensor may set the prior distribution of the historical data of the target sensor. In this case, the prior distribution may be the prior distribution of the regression coefficient and the error term of the regression curve representing the correlation between the historical data of the target sensor and the historical data of the plurality of sensors not selected as the target sensor, though not limited thereto.

According to various embodiments, in step of S410, the device 100 for determining the operational status of a sensor may set the prior distribution of the historical data of the reference sensor. In this case, the prior distribution may be the prior distribution of the regression coefficient and the error term of the regression curve representing the correlation between the historical data of the target sensor and the historical data of the reference sensor, though not limited thereto.

According to various embodiments, in step of S410, the device 100 for determining the operational status of a sensor may generate training data by performing sampling in the historical data of the target sensor, the prior distribution of the historical data of the target sensor, the historical data of the reference sensor, and the prior distribution of the historical data of the reference sensor.

According to various embodiments, in step of S410, the device 100 for determining the operational status of a sensor may calculate a likelihood, also referred to as a likelihood function, using historical data of the target sensor. The likelihood calculation is well known to person in the skilled in this field and therefore, a detailed description thereof will be omitted.

According to various embodiments, in step of S420, the device 100 for determining the operational status of a sensor may obtain the posterior distribution of the historical data of the target sensor and the historical data of the reference sensor based on the training data generated by means of sampling.

According to various embodiments, the posterior distribution of the regression coefficient and the error term of the regression curve representing the correlation between the historical data of the target sensor and the historical data of the reference sensor which is obtained by the device 100 for determining the operational status of a sensor may be expressed by using the following [Equation 7] based on the training data, the likelihood of the historical data of the target sensor, the likelihood of the historical data of the reference sensor, the set prior distribution of the historical data of the target sensor, and the set prior distribution of the historical data of the reference sensor.

$$P ( H \vert D ) = \frac{P ( D \vert H ) P ( H )}{P ( D )} \qquad [ Equation 7 ]$$

Here, P(H|D) is the posterior distribution, P(D|H) is the likelihood, P(H) is the prior distribution of the data, and P(D)) is a probability over the data.

According to various embodiments, in step of S430, the device 100 for determining the operational status of a sensor may validate a training state of the Bayesian model by comparing the posterior distribution obtained by using the Bayesian model with a preset reference value. At this time, the preset reference value may be an acceptance rate and autocorrelation, but is not limited thereto.

According to various embodiments, in step of S430, the device 100 for determining the operational status of a sensor may determine re-training of the Bayesian model if the posterior distribution obtained by using the Bayesian model cannot satisfy both the acceptance rate (for example, 0.2<=acceptance rate <=0.5) and the autocorrelation (for example, 50% of the sample is within 95% of the credible interval).

According to various embodiments, in step of S430, the device 100 for determining the operational status of a sensor may train the Bayesian model repeatedly based on the new training data sampled in the historical data of the target sensor, the posterior distribution of the historical data of the target sensor, the historical data of the reference sensor, and the prior distribution of the historical data of the reference sensor, until the posterior distribution obtained by using the Bayesian model satisfies both the acceptance rate (for example, 0.2<=acceptance rate <=0.5) and the autocorrelation (for example, 50% of the sample is within 95% of the credible interval).

According to various embodiments, in step of S430, the device 100 for determining the operational status of a sensor may stop training of the Bayesian model if the posterior distribution obtained by using the Bayesian model satisfies both the acceptance rate (for example, 0.2<=acceptance rate <=0.5) and the autocorrelation (for example, 50% of the sample is within 95% of the credible interval).

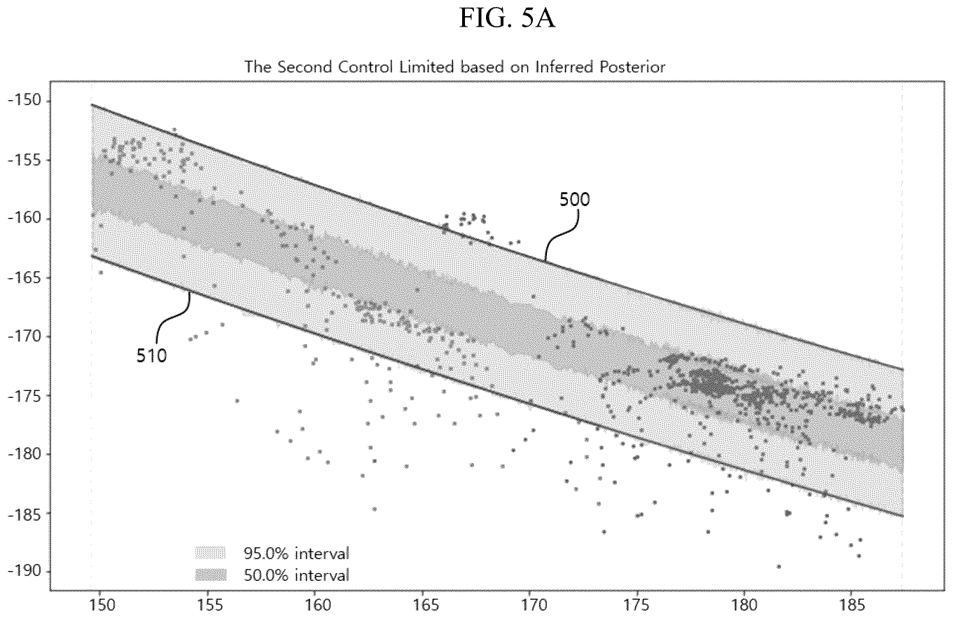

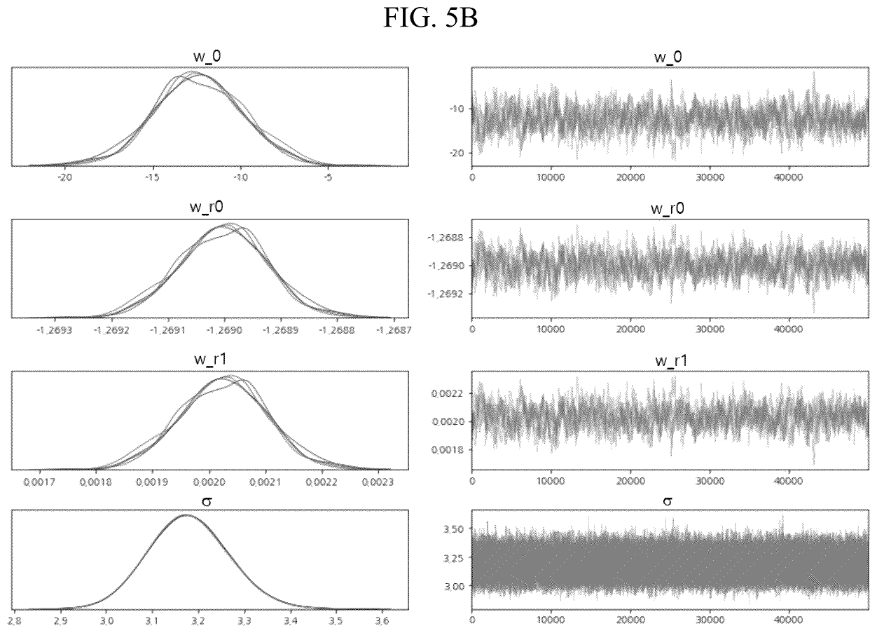

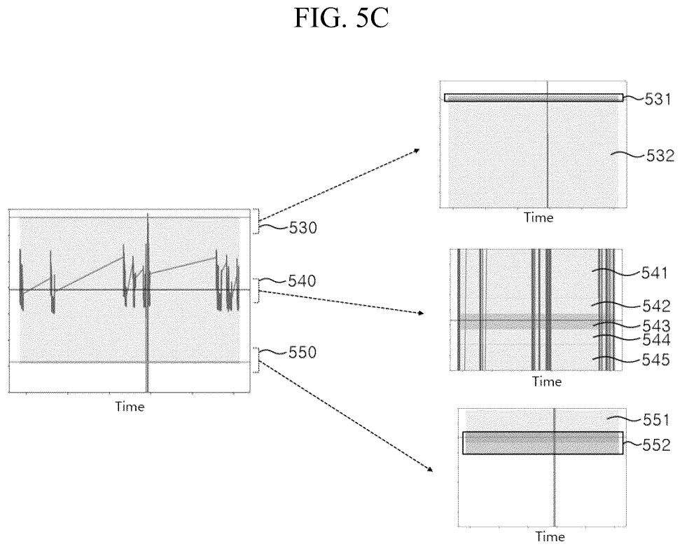

FIGS. 5A to 5C are views exemplarily showing the safe region, the attention region, and the control lines according to an embodiment of the present disclosure.

Referring to FIG. 5A, upper and lower control lines are illustrated in FIG. 5A.

A region illustrated at a center of FIG. 5A shows an expected value of the posterior distribution of the mean in FIG. 5B.

In FIG. 5A, a line 500 represents \check{μ}_{avg}+3\check{σ}_{avg} which is an upper control line in [Equation 8] below, and a line 510 represents \check{μ}_{avg}−3\check{σ}_{avg} which is a lower control line in [Equation 8] below.

$${\check{μ}}_{avg} - 3 {\check{σ}}_{avg} \leq {\check{X}}_{CL} \leq {\check{μ}}_{avg} + 3 {\check{σ}}_{avg} \qquad [ Equation 8 ]$$

FIG. 5B shows examples of graphs of the posterior distribution of each regression coefficient (w₀, wᵣ₀, wᵣ₁) and the error term (σ) in the equation Y=w₀+wᵣ₀x+wᵣ₁x²+σ.

Referring to FIG. 5B, the graphs on the left column show the posterior distribution of each regression coefficient and the error term, and the graphs on the right column show examples of the samples obtained by the Bayesian sampling inference.

FIG. 5C illustrates a region corresponding to Equations 9-13.

$${\check{μ}}_{hpd 25 \%} \leq {\check{μ}}_{CI 50 \%} \leq {\check{μ}}_{hpd 75 \%} \qquad [ Equation 9 ]$$

$${\check{μ}}_{hpd 25 \%} - 3 {\check{σ}}_{hpd 75 \%} \leq {\check{X}}_{CI 50 \%} \leq {\check{μ}}_{hpd 75 \%} + 3 {\check{σ}}_{hpd 75 \%} \qquad [ Equation 10 ]$$

$${\check{μ}}_{hpd 2.5 \%} \leq {\check{μ}}_{CI 95 \%} \leq {\check{μ}}_{hpd 97.5 \%} \qquad [ Equation 11 ]$$

$${\check{μ}}_{hpd 2.5 \%} - 3 {\check{σ}}_{hpd 97.5 \%} \leq {\check{X}}_{CI 95 \%} \leq {\check{μ}}_{97.5 \%} + 3 {\check{σ}}_{hpd 97.5 \%} \qquad [ Equation 12 ]$$

$${\check{μ}}_{avg} - 3 {\check{σ}}_{avg} \leq {\check{X}}_{CL} \leq {\check{μ}}_{avg} + 3 {\check{σ}}_{avg} \qquad [ Equation 13 ]$$

Referring to FIG. 5C, the graph located at the top of the right column provides an enlarged view of the graph situated in the left column, specifically at section 530 at time t. 531 represents the upper control line (\check{μ}_{avg}+3\check{σ}_{avg}) and an upper limit of the standard deviation of the attention region (\check{μ}_{97.5%}+3\check{σ}_{hpd97.5%}). In addition, 532 represents part of the upper limit of the standard deviation of the safe region (\check{μ}_{hpd75%}+3\check{σ}_{hpd75%}).

The graph located at the middle of the right column provides an enlarged view of the graph situated in the left column, specifically at section 540 at time t. 541 represents part of the upper limit of the standard deviation of the safe region (\check{μ}_{hpd75%}+3\check{σ}_{hpd75%}), and 542 and 544 represent the upper limit (\check{μ}_{hpd97.5%})(542) and the lower limit of the mean (\check{μ}_{hpd2.5%})(54) of a mean of the attention region. In addition, 545 represents part of the lower limit of the standard deviation of the safe region (μ_{hpd2.5%}−3\check{σ}_{hpd97.5%}). 543 represents [Equation 13].

The graph located at the bottom of the right column provides an enlarged view of the graph situated in the left column, specifically at section 550 at time t. 551 represents part of the lower limit of the standard deviation of the safe region (\check{μ}_{hpd25%}−3\check{σ}_{hpd75%}). In addition, 552 represents part of the lower control line (\check{μ}_{avg}−3\check{σ}_{avg}) and the lower limit of the standard deviation of the attention region \check{μ}_{hpd2.5%}−3\check{σ}_{hpd97.5%}).

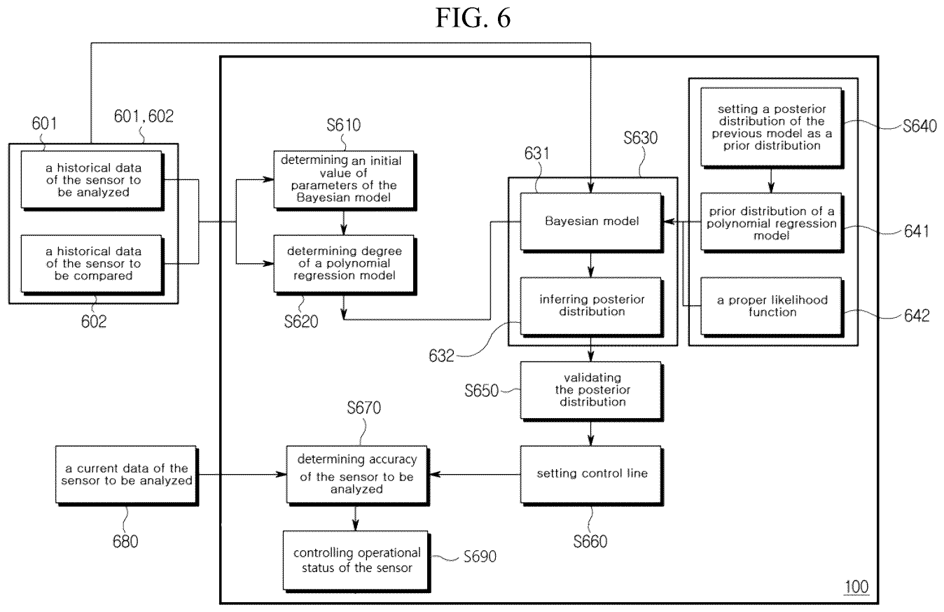

FIG. 6 is a flowchart explaining a method for determining the operational status of the sensor to which the polynomial regression model is applied according to an embodiment of the present disclosure.

Referring to FIG. 6, the device 100 for determining the operational status of a sensor may determine (S610) the initial value of the parameter of the Bayesian model by obtaining the historical data of the target sensor 601 and the historical data of the reference sensor 602.

According to various embodiments, the device 100 for determining the operational status of a sensor may determine (S620) the degree of the polynomial regression model by obtaining the historical data of the target sensor 601, the historical data of the reference sensor 602.

According to various embodiments, the device 100 for determining the operational status of a sensor may infer (S630) the posterior distribution 632 of the regression coefficient and the error term of the regression curve representing the correlation between the historical data of the target sensor and the historical data of the reference sensor, by inputting the prior distribution of the coefficient and the standard deviation set based on the degree of the polynomial regression model, the historical data of the target sensor, and the historical data of the reference sensor into the optimized Bayesian model.

According to various embodiments, the device 100 for determining the operational status of a sensor may set the prior distribution of the coefficient and the standard deviation set based on the degree of the polynomial regression model with the posterior distribution of the previous model (641), and attune the control lines by setting a proper likelihood function (642)(S640).

According to various embodiments, the device 100 for determining the operational status of a sensor may validate convergence based on an ESS (Effective Sample Size) value (for example, ESS>500) and a R-hat value after Burn-in and Thinning (for example, 0.95<R-hat<1.05)(S650).

According to various embodiments, the device 100 for determining the operational status of a sensor may set a targeted credible interval with respect to the inferred posterior distribution of the regression coefficient and the error term of the regression curve representing the correlation between the historical data of the target sensor and the historical data of the reference sensor, and set the control lines of the data of the target sensor by using the set credible interval (S660).

According to various embodiments, the device 100 for determining the operational status of a sensor may determine the accuracy of the target sensor by comparing the current data of the target sensor (680) with the set control lines (S670).

According to various embodiments, the device 100 for determining the operational status of a sensor may control the operational status of the target sensor (S690).

While the present disclosure has been described with reference to the exemplary embodiment shown in the drawings, this is merely illustrative, and it will be understood by those skilled in the art that various modifications and equivalent other exemplary embodiments therefrom are available. Therefore, the true technical scope of the present disclosure should be determined by the technical spirit of the appended claims.

What is claimed is:

1. A device for determining an operational status of a sensor, comprising:
at least one processor, and
at least one memory coupled to the at least one processor, wherein the at least one memory is configured to provide the at least one processor with instructions which, when executed, causes the at least one processor to:
determine initial values of parameters of a Bayesian model and a degree of a polynomial regression model based on historical data of a target sensor and historical data of a reference sensor;
infer a posterior distribution of a regression coefficient and an error term of a regression curve representing a correlation between the historical data of the target sensor and the historical data of the reference sensor using the polynomial regression model and the Bayesian model;
set a credible interval based on the posterior distribution of the regression coefficient and the error term of the regression curve, and set control lines of data of the target sensor using the credible interval;
determine an accuracy of the target sensor based on current data of the target sensor and the control lines; and
control an operational status of the target sensor based on the accuracy.

2. The device of claim 1,
wherein the at least one processor is further configured to determine the historical data of the reference sensor using a distance correlation between the historical data of the target sensor and historical data of a plurality of sensors not selected as the target sensor.

3. The device of claim 1,
wherein the at least one processor is further configured to replace a prior distribution determined based on the polynomial regression model with a posterior distribution of a previous polynomial regression model, and
set a likelihood function.

4. The device of claim 1,
wherein the at least one processor is further configured to validate the posterior distribution of the regression coefficient and the error term of the regression curve based on a preset method.

5. The device of claim 1,
wherein the at least one processor is further configured to:
set the credible interval based on a highest posterior density value having a preset percentage (%) of an expected value of the posterior distribution of the regression coefficient and the error term of the regression curve, and
set the control lines of the data of the target sensor using lower and upper boundary values of the posterior distribution of the regression coefficient and the error term of the regression curve, with the lower and upper boundary values corresponding to lower and upper limits of the credible interval, respectively.

6. A method for determining an operational status of a sensor, comprising:
determining initial values of parameters of a Bayesian model and a degree of a polynomial regression model based on historical data of a target sensor and historical data of a reference sensor;
inferring a posterior distribution of a regression coefficient and an error term of a regression curve representing a correlation between the historical data of the target sensor and the historical data of the reference sensor using the polynomial regression model and the Bayesian model;
setting a credible interval based on the posterior distribution of the regression coefficient and the error term of the regression curve, and setting control lines of data of the target sensor using the credible interval;
determining an accuracy of the target sensor based on current data of the target sensor and the control lines; and
controlling an operational status of the target sensor based on the accuracy.

7. The method of claim 6, further comprising:
determining the historical data of the reference sensor using a distance correlation between the historical data of the target sensor and historical data of a plurality of sensors not selected as the target sensor.

8. The method of claim 6,
wherein the inferring of the posterior distribution of the regression coefficient and the error term of the regression curve comprises:
replacing a prior distribution determined based on the polynomial regression model with a posterior distribution of a previous polynomial regression model, and
setting a likelihood function.

9. The method of claim 6,
wherein the inferring of the posterior distribution of the regression coefficient and the error term of the regression curve comprises:
validating the posterior distribution of the regression coefficient and the error term of the regression curve based on a preset method.

10. The method of claim 6,
wherein the setting of the control lines of the data of the target sensor comprises:
setting the credible interval based on a highest posterior density value having a preset percentage (%) of an expected value of the posterior distribution of the regression coefficient and the error term of the regression curve; and
setting the control lines of the data of the target sensor using lower and upper boundary values of the posterior distribution of the regression coefficient and the error term of the regression curve, with the lower and upper boundary values corresponding to lower and upper limits of the credible interval.

11. A non-transitory computer-readable storage medium storing instructions of executing the method of claim 6.
